(19) United States
(12) Patent Application Publication
(10) Pub. No.: US 2019/0036334 A1
(43) Pub. Date: Jan. 31, 2019

(54) HARMONIC CONTROL

(71) Applicants: Marc SOLER JAUMA, Sant Cugat del Valles (ES); David SORIANO FOSAS, Sant Cugat del Valles (ES); Marina FERRAN FERRES, Sant Cugat del Valles (ES); HEWLETT-PACKARD DEVELOPMENT COMPANY, L.P., Houston, TX (US)

(72) Inventors: Marc Soler Jauma, Cabrils (ES); David Soriano Fosas, Terrassa (ES); Marina Ferran Farres, Barcelona (ES)

(21) Appl. No.: 16/069,511

(22) PCT Filed: Apr. 1, 2016
(86) PCT No.: PCT/EP2016/057290

§ 371 Date: Jul. 11, 2018

(51) Int. Cl. H02J 3/01; G03G 15/00

(52) U.S. Cl. CPC H02J 3/01; G03G 15/80

(57) ABSTRACT

There is provided a method and apparatus for controlling harmonics. For each device in an array of devices, a level of harmonic control is acquired to apply to an alternating current voltage powering the device. The level of harmonic control defines a period in a cycle of the alternating current voltage in which to drop the alternating current voltage. For each device in an array of devices, the alternating current voltage powering the device is controlled by dropping the alternating current voltage in the period defined by the acquired level of harmonic control.

### BACKGROUND

An alternating current voltage signal can be distorted by harmonics. In other words, an alternating current voltage signal can contain energy at harmonic frequencies as well as the energy at the fundamental frequency. This causes voltage fluctuations in the alternating current voltage signal. As a result, a device powered by an alternating current voltage distorted by harmonics can operate in an unstable way, overheat, malfunction, operate at a reduced power, or similar. The device may not pass voltage variation regulations.

### BRIEF DESCRIPTION OF DRAWINGS

For a more complete understanding, various examples will now be described below with reference to the accompanying drawings in which:

FIG. 1 is a block diagram of an apparatus according to an example;

FIG. 2 illustrates a block diagram of the apparatus in use in a system according to an example;

FIG. 3 is an illustration of a process employed according to an example;

FIGS. 4A, 4B and 4C illustrate alternating current voltages according to an example; and

FIG. 5 illustrates alternating current voltages powering an array of devices according to an example; and

FIG. 6 is a block diagram of a computing system according to an example.

### DETAILED DESCRIPTION

Some examples described herein provide an apparatus and method for controlling harmonics in an alternating current voltage powering (i.e. supplying power to) a device.

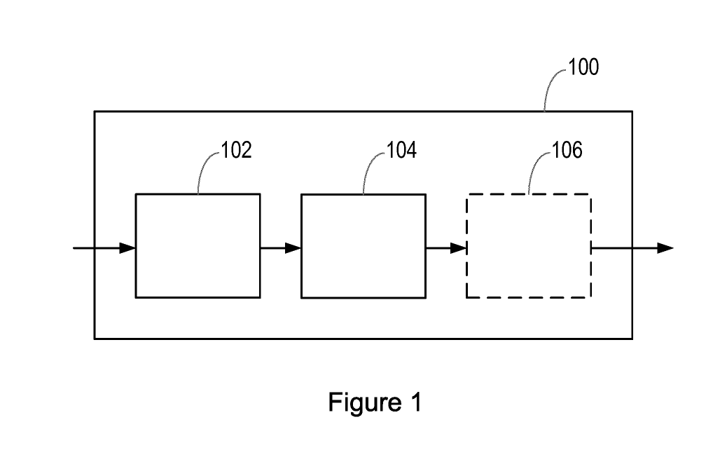

The present subject-matter is further described with reference to FIGS. 1, 2, 3, 4, 5 and 6. It should be noted that the description and figures merely illustrate principles of the present subject-matter. It is thus understood that various arrangements may be devised that, although not explicitly described or shown herein, embody the principles of the present subject-matter. Moreover, all statements herein reciting principles and examples of the present-subject matter, as well as specific examples thereof, are intended to encompass equivalents thereof.

FIG. 1 illustrates a block diagram of an apparatus 100 according to an example. The apparatus 100 comprises an acquisition module 102 to acquire, for each device in an array of devices, a level of harmonic control to apply to an alternating current voltage provided to (i.e. powering) the device.

The level of harmonic control identifies a period in a cycle of the alternating current voltage in which to drop the alternating current voltage. As used herein, the term “drop” used in connection with alternating current voltage refers to the instant when the alternating current voltage is no longer passed to the device. For example, this may be the instant when a pass switch or pass mosfet is stopped. The term “drop” as used herein may be used interchangeably with the terms “cut”, “chop”, “switch off”, “drop out”, “cease providing”, “trim”, or similar. The apparatus 100 comprises a control module 104 to control, for each device in the array of devices, the alternating current voltage provided to the device by dropping (i.e. cutting, chopping, switching off, dropping out, ceasing to provide, trimming, or similar) the alternating current voltage in the period identified by the level of harmonic control for the device.

In some examples, the level of harmonic control is acquired from a database comprising data representing different levels of harmonic control. The database may be part of the apparatus 100 or a separate database. In other examples, the level of harmonic control is acquired as a predetermined level of harmonic control for the device. Some devices in the array of devices may have a level of harmonic control acquired from the database comprising data representing different levels of harmonic control, whilst other devices in the array of devices may have a level of harmonic control acquired as the predetermined level of harmonic control for that device. In other examples, each of the devices in the array of devices has a level of harmonic control acquired from the database comprising data representing different levels of harmonic control or each of the devices in the array of devices has a level of harmonic control acquired as the predetermined level of harmonic control for those devices.

The apparatus 100 may comprise a sensor module 106 to determine a property (i.e. a characteristic) associated with the device. For example, the sensor module 106 may determine an amount of power in the device, a speed at which the device is operating and/or a level of interference (or noise) experienced by the device. In one example, the sensor module 106 to determine an amount of power in the device may be any sensor capable of sensing power such as a power meter, a single-phase energy meter, or similar. In another example, the sensor module 106 of the apparatus 100 to determine a speed at which the device is operating may be any sensor capable of sensing device speed such as a Hall Effect sensor, or similar. In another example, the sensor module 106 of the apparatus 100 to determine a level of interference (or noise) experienced by the device may be any sensor capable of sensing interference such as an audio distortion meter, or similar. The sensor module 102 may comprise a set of sensors (i.e. may comprise multiple sensors) comprising the same type of sensors or any combination of types of sensors. Although examples of sensors are provided, it will be understood that other sensors and combinations of sensors can be used.

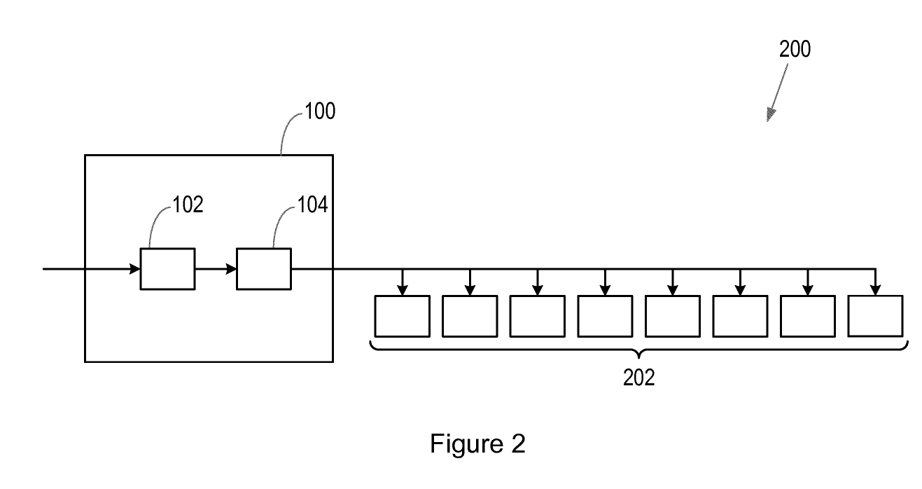

FIG. 2 illustrates a block diagram of the apparatus 100 in use in a system 200 according to an example. The system 200 comprises an array of devices 202. Although this illustrated example shows an array of 8 devices, it will be understood that the array of devices 202 can comprise any number of devices. For example, the array of devices may comprise 2 devices, 3, devices, 4 devices and so on. In another example, the array of devices may contain more than 20 devices such as 21 devices, 25 devices, 30 devices, or any other number of devices above 20. However, these are merely examples and any number of devices can be controlled in the manner described herein. The control module 104 of the apparatus 100 controls the alternating current provided to the array of devices 202, as described herein.

In some examples, the array of devices 202 can be any array of devices that can be harmonically controlled. In some examples, the array of devices 202 may be an array of devices in a printing apparatus (or printer), or a photocopier, or an image scanning apparatus, or similar. The printing apparatus may be a two-dimensional printer, a three-dimensional printer, or any other printing apparatus.

The array of devices 202 may comprise devices of any type. For example, a device may be a heating device (for example, a lamp such as an infra-red lamp, any type of filament based heating device, a thermal based curing device or any other heating device), a power fusing device, an alternating current motor, any other alternating current load, or any other device. In some examples, the devices in the array of devices are all of the same type of device. In other examples, the array of devices comprises any combination of different types of devices. Although examples of devices are provided, it will be understood that other devices or combinations of devices can be controlled using the apparatus 100. In other words, the apparatus 100 can control any array of devices that can be harmonically controlled.

In some examples, the apparatus 100 is part of an apparatus comprising an array of devices that can be harmonically controlled. For example, the apparatus 100 may be part of a printing apparatus (or printer), or a photocopier, or an image scanning apparatus, or similar, comprising an array of devices that can be harmonically controlled (such as any of those devices described above). The printing apparatus may be a two-dimensional printer, a three-dimensional printer, or any other printing apparatus.

In some examples, the apparatus 100 is an external apparatus (i.e. an apparatus that is separate to or remote from the apparatus comprising an array of devices that can be harmonically controlled). For example, the apparatus 100 may be an external apparatus that controls an array of devices (such as any of those devices described above) in a printing apparatus (or printer), or a photocopier, or an image scanning apparatus, or similar. The printing apparatus may be a two-dimensional printer, a three-dimensional printer, or any other printing apparatus.

In some examples, the apparatus 100 is any apparatus comprising an array of devices that can be harmonically controlled. For example, the apparatus 100 may be a printing apparatus (or printer), or a photocopier, or an image scanning apparatus, or similar, comprising an array of devices that can be harmonically controlled (such as any of those devices described above). The printing apparatus may be a two-dimensional printer, a three-dimensional printer, or any other printing apparatus.

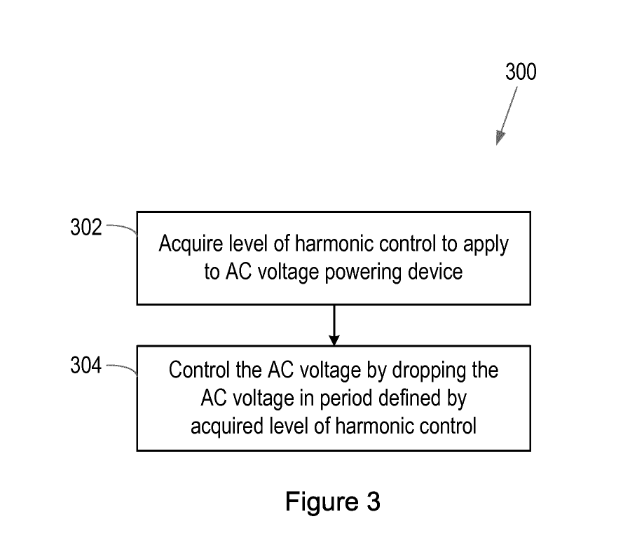

FIG. 3 illustrates a process 300 employed according to an example. The process 300 (including blocks 302 and 304) is executed for each device in the array of devices 202.

At block 302 of FIG. 3, a level of harmonic control to apply to an alternating current (AC) voltage powering the device is acquired. The level of harmonic control defines a period in a cycle of the alternating current voltage in which to drop the alternating current voltage. For example, the alternating current voltage may be dropped in each cycle of the alternating current voltage. The acquisition module 102 of the apparatus 100 acquires the level of harmonic control to apply. As described earlier, the level of harmonic control may be acquired as a predetermined level of harmonic control for the device or may be acquired from a database comprising data representing different levels of harmonic control. The database may be part of the apparatus 100 or a separate database.

In some examples, a level of harmonic control (i.e. a level of trimming) may be denoted by an integer value N. This integer value N may be any integer value (for example, N may have a value of 1, 2, 3, 4, 5, or any other integer value). The levels of harmonic control denoted by different integer values N can define different periods of the alternating current voltage in which to drop the alternating current voltage. In other words, any number of levels of harmonic control can be acquired in the manner described earlier. The number of levels of harmonic control is customisable.

The integer value N can be used to express the relationship between the frequency of the alternating current voltage signal and the frequency at which the alternating current voltage signal is dropped (i.e. the frequency of trimming), as follows:

FreqTrim=FreqAC*2/N, (1)

where FreqTrim is the frequency at which the alternating current voltage signal is dropped (i.e. the frequency of trimming) and FreqAC is the frequency of the alternating current voltage signal.

The larger the value of N, the slower the frequency at which the alternating current voltage signal is dropped (i.e. the slower the frequency of trimming) and the larger the power consumption of the device. N can be reduced to increase the frequency at which the alternating current voltage signal is dropped. This reduces the power consumption of the device and increases the harmonics in the alternating current voltage signal. N can be increased to reduce the frequency at which the alternating current voltage signal is dropped. This reduces the harmonics in the alternating current voltage signal and increases the power consumption of the device.

In some examples, at block 302 of FIG. 3, acquiring a level of harmonic control to apply to an alternating current voltage powering the device comprises acquiring a level of harmonic control to apply that is a lowest level of harmonic control to generate harmonics in the alternating current voltage that conform to a regulation (i.e. that do not exceed or are below a threshold for harmonic current emissions). In other words, the harmonics are controlled to pass a threshold or regulatory level. For example, the integer value N can be chosen to be the lowest value that will generate harmonics in the alternating current voltage that conform to a regulation. In other words, the frequency at which the alternating current voltage signal is dropped can be set to the highest value that will generate harmonics in the alternating current voltage that conform to a regulation. In some examples, acquiring a level of harmonic control to apply to an alternating current voltage powering the device comprises acquiring a level of harmonic control that is optimum to reduce the power consumption of the device whilst not exceeding a threshold for harmonics in the alternating current voltage.

In some examples, the regulation may be the “Electromagnetic Compatibility (EMC)—Part 3-2: Limits—Limits for harmonic current emission (equipment input currents 16 A per phase)”, IEC 61000-3-2, and/or the “Electromagnetic compatibility (EMC)—Part 3-3: Limits—Limitation of voltage changes, voltage fluctuations and flicker in public low-voltage supply systems, for equipment with rated current ≤16 A per phase and not subject to conditional connection”, IEC 61000-3-3.

At block 304 of FIG. 3, the alternating current voltage powering the device is controlled by dropping the alternating current voltage in the period defined by the acquired level of harmonic control. The control module 104 of the apparatus 100 controls the alternating current voltage powering the device.

In some examples, the devices in the array of devices 202 are controlled separately (i.e. independently or individually). In these examples, some or all of the devices in the array of devices 202 may be controlled using different levels of harmonic control or all of the devices in the array of devices 202 may be controlled using the same level of harmonic control. The level of harmonic control acquired for a device in the array of devices may be dependent on the level of harmonic control acquired for another device in the array of devices. In other examples, the devices in the array of devices 202 are controlled together (i.e. collectively or as one). In these examples, the devices in the array of devices 202 may be controlled using the same level of harmonic control.

In some examples, the process 300 (including blocks 302 and 304) may be repeated by determining whether to acquire a different level of harmonic control to apply to the alternating current voltage powering the device or whether to continue powering the device with the previously acquired level of harmonic control applied to the alternating current voltage. For example, the process 300 may be repeated at set time intervals such as by use of a timer.

In some examples, the process 300 may comprise determining an amount of power in the device and, at block 302, acquiring a level of harmonic control to apply to the alternating current voltage powering the device may comprise acquiring a level of harmonic control to apply to the alternating current voltage powering the device based on the determined amount of power in the device. The amount of power in the device can be determined at the start of the process 300 (i.e. before block 302) and/or can be determined at the end of the process 300 (i.e. after block 304). Where the amount of power in the device is determined at the end of the process 300 (i.e. after block 304), the process 300 may be repeated by determining whether to acquire a different level of harmonic control to apply to the alternating current voltage powering the device or whether to continue powering the device with the previously acquired level of harmonic control applied to the alternating current voltage. This determination is based on the determined amount of power in the device.

In some examples, the process 300 may comprise determining a speed at which the device is operating and, at block 302, acquiring a level of harmonic control to apply to the alternating current voltage powering the device may comprise acquiring a level of harmonic control to apply to the alternating current voltage powering the device based on the determined speed at which the device is operating. The speed at which the device is operating can be determined at the start of the process 300 (i.e. before block 302) and/or can be determined at the end of the process 300 (i.e. after block 304). Where the speed at which the device is operating is determined at the end of the process 300 (i.e. after block 304), the process 300 may be repeated by determining whether to acquire a different level of harmonic control to apply to the alternating current voltage powering the device or whether to continue powering the device with the previously acquired level of harmonic control applied to the alternating current voltage. This determination is based on the determined speed at which the device is operating.

In some examples, the process 300 may comprise determining a level of interference (or noise) experienced by the device and, at block 302, acquiring a level of harmonic control to apply to the alternating current voltage powering the device may comprise acquiring a level of harmonic control to apply to the alternating current voltage powering the device based on the determined level of interference (or noise) experienced by the device. The level of interference (or noise) experienced by the device can be determined at the start of the process 300 (i.e. before block 302) and/or can be determined at the end of the process 300 (i.e. after block 304). Where the level of interference (or noise) experienced by the device is determined at the end of the process 300 (i.e. after block 304), the process 300 may be repeated by determining whether to acquire a different level of harmonic control to apply to the alternating current voltage powering the device or whether to continue powering the device with the previously acquired level of harmonic control applied to the alternating current voltage. This determination is based on the determined level of interference (or noise) experienced by the device.

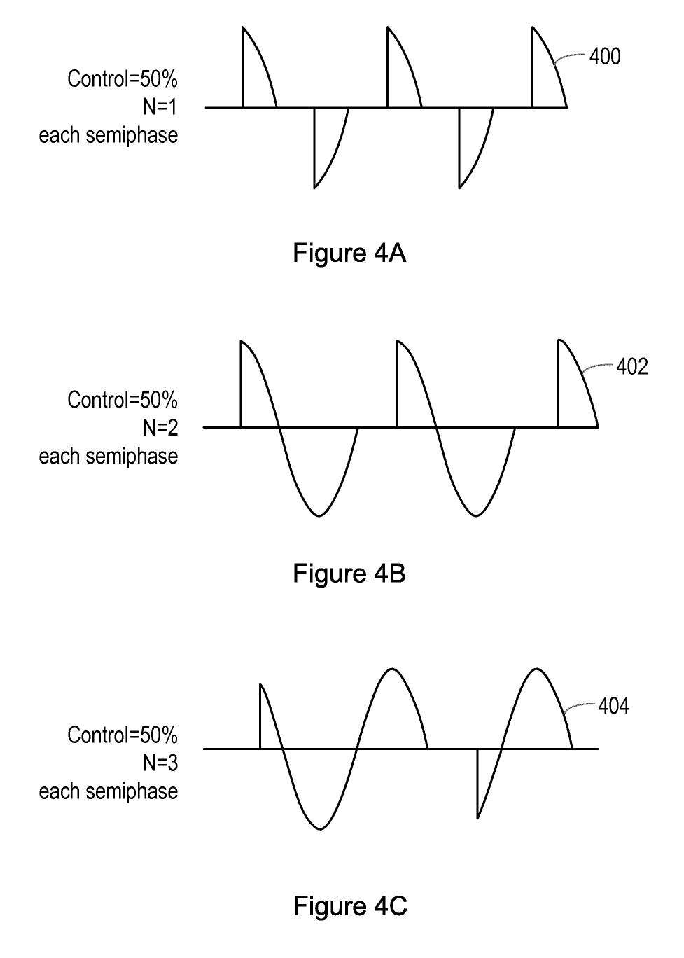

FIGS. 4A, 4B and 4C illustrate some examples of alternating current voltages with applied levels of harmonic control. Although three levels of harmonic control (i.e. N=1, N=2, and N=3) are illustrated in this example, it will be understood that other levels of harmonic control are possible.

In FIG. 4A, the level of harmonic control (denoted by N=1) defines a period of the alternating current voltage in which to drop the alternating current voltage as a period of a ¼ cycle every ½ cycle of the alternating current voltage. As illustrated, the alternating current voltage is dropped at zero for a ¼ cycle and this is repeated every ½ cycle of the alternating current voltage. In other words, the alternating current voltage is applied for a period of a ¼ cycle in each ½ cycle of the alternating current voltage. The alternating current voltage 400 illustrated in FIG. 4A has this level of harmonic control applied (i.e. is controlled using this level of harmonic control). Based on equation (1) above, if the frequency of the alternating current voltage signal is 60 Hz in this example, the frequency at which the alternating current voltage signal is dropped (i.e. the frequency of trimming) is 120 Hz.

In FIG. 4B, the level of harmonic control (denoted by N=2) defines a period of the alternating current voltage in which to drop the alternating current voltage as a period of a ¼ cycle every cycle of the alternating current voltage. As illustrated, the alternating current voltage is dropped at zero for a ¼ cycle and this is repeated every cycle of the alternating current voltage. In other words, the alternating current voltage is applied for a period of a ¾ cycle in each cycle of the alternating current voltage. The alternating current voltage 402 illustrated in FIG. 4B has this level of harmonic control applied (i.e. is controlled using this level of harmonic control). Based on equation (1) above, if the frequency of the alternating current voltage signal is 60 Hz in this example, the frequency at which the alternating current voltage signal is dropped (i.e. the frequency of trimming) is 60 Hz.

In FIG. 4C, the level of harmonic control (denoted by N=3) defines a period of the alternating current voltage in which to drop the alternating current voltage as a period of ⅜ of a cycle every 1½ cycles of the alternating current voltage. As illustrated, the alternating current voltage is dropped at zero for ⅜ of a cycle and this is repeated every 1½ cycles of the alternating current voltage. In other words, the alternating current voltage is applied for a period of one and ⅛ of a cycle each 1½ cycles of the alternating current voltage. The alternating current voltage 404 illustrated in FIG. 4C has this level of harmonic control applied (i.e. is controlled using this level of harmonic control). Based on equation (1) above, if the frequency of the alternating current voltage signal is 60 Hz in this example, the frequency at which the alternating current voltage signal is dropped (i.e. the frequency of trimming) is 40 Hz.

Although examples have been provided for levels of harmonic control that can be acquired, it will be understood that other levels of harmonic control are possible. Also, although three levels of harmonic control are provided as an example, any other number of levels of harmonic control can be acquired.

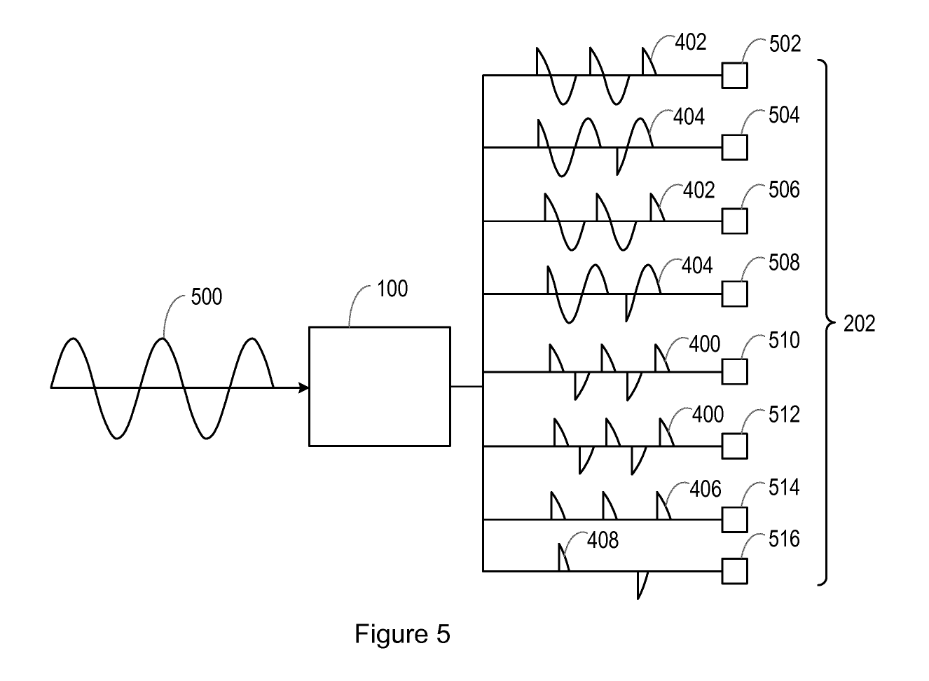

FIG. 5 illustrates alternating current voltages powering an array of devices according to an example in which the devices in the array of devices 202 are controlled separately. In this example, the array of devices 202 comprises eight devices 502, 504, 506, 508, 510, 512, 514 and 516. As shown in FIG. 5, an alternating current voltage signal 500 is received at the apparatus 100. The acquisition module 102 of the apparatus 100 acquires the level of harmonic control to apply and the control module 104 of the apparatus 100 controls the alternating current voltage powering the device, as described earlier. In the example illustrated in FIG. 5, the devices are controlled using five different levels of harmonic control.

The devices 502 and 506 of the array of devices 202 are powered by the alternating current voltage 402 of FIG. 4B. In other words, the alternating current voltage 500 supplied to devices 502 and 506 is controlled to drop the alternating current voltage for a period of a ¼ cycle every cycle of the alternating current voltage according to the level of harmonic control denoted by N=2. The devices 504 and 508 of the array of devices 202 are powered by the alternating current voltage 404 of FIG. 4C. In other words, the alternating current voltage 500 supplied to devices 504 and 508 is controlled to drop the alternating current voltage for a period of a ⅜ cycle every 1½ cycles of the alternating current voltage according to the level of harmonic control denoted by N=3. The devices 510 and 512 of the array of devices 202 are powered by the alternating current voltage 400 of FIG. 4A. In other words, the alternating current voltage 500 supplied to devices 510 and 512 is controlled to drop the alternating current voltage for a period of a ¼ cycle every ½ cycle of the alternating current voltage according to the level of harmonic control denoted by N=1.

The device 514 of the array of devices 202 is powered by an alternating current voltage 406 in which the alternating current voltage 500 is controlled using a level of harmonic control in which the alternating current voltage is dropped for a period of a ¾ cycle every cycle of the alternating current voltage. In other words, the device 514 of the array of devices 202 is powered by an alternating current voltage 406 in which the alternating current voltage 500 is controlled using a level of harmonic control in which the alternating current voltage is applied for a period of a ¼ cycle in each cycle of the alternating current voltage. The device 516 of the array of devices 202 is powered by an alternating current voltage 408 in which the alternating current voltage 500 is controlled using a level of harmonic control in which the alternating current voltage is dropped for a period of a 1 and ⅜ cycle every 1½ cycle of the alternating current voltage. In other words, the device 516 of the array of devices 202 is powered by an alternating current voltage 408 in which the alternating current voltage 500 is controlled using a level of harmonic control in which the alternating current voltage is applied for a period of a ¼ cycle every other cycle of the alternating current voltage.

Although the example of FIG. 5 illustrates an array of 8 devices with 5 different levels of harmonic control, it will be understood that any other number of devices and levels of harmonic control can be provided. For example, an array of 7 devices may be provided with 3 levels of harmonic control. In this way, there are in effect 21 devices in the array since 7 devices can be powered in 3 different ways. However, any other numbers of devices and levels of harmonic control are also possible.

In some examples, where the device is a heating device, the process 300 may comprise providing heat to a build surface (such as a print surface) using the device powered by the controlled alternating current voltage. In these examples, the level of harmonic control to apply to the alternating current voltage powering the heating device may be acquired such that the array of heating devices heat the build surface uniformly (i.e. provide a stable and homogenous temperature over the build surface) or non-uniformly (i.e. provide different temperatures over the build surface). Where the build surface is heated uniformly, the heating devices in the array of heating devices may be controlled separately.

In some examples, the process 300 may also comprise generating an object by applying layers of build material to a build surface. In this example, the process 300 (including blocks 302 and 304) may be repeated for each layer of build material that is applied to the build surface or each time a predefined number of layers of build material are applied to the build surface. The device may be a heating device powered by the controlled alternating current voltage to provide heat to the build surface and any applied layer of build material. The build material may be applied by an additive manufacturing technique. Additive manufacturing techniques may generate a three-dimensional object through the solidification of the build material. In examples of such techniques, build material is supplied in a layer-wise manner and the solidification method includes heating the layers of build material to cause melting in selected regions. In other techniques, chemical solidification methods may be used.

As mentioned above, additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a build surface or print bed and processed layer by layer, for example within a fabrication chamber manner.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a coalescing agent (also termed a ‘coalescence agent’ or ‘fusing agent’) may be selectively distributed onto portions of a layer of build material in a pattern derived from data representing a slice of a three-dimensional object to be generated (which may for example be generated from structural design data). The coalescing agent may have a composition which absorbs energy such that, when energy (for example, heat) is applied to the layer, the build material coalesces and solidifies to form a slice of the three-dimensional object in accordance with the pattern. In other examples, coalescence may be achieved in some other manner.

In addition to a coalescing agent, in some examples, a print agent may comprise a coalescence modifier agent, which acts to modify the effects of a coalescing agent for example by reducing or increasing coalescence or to assist in producing a particular finish or appearance to an object, and such agents may therefore be termed detailing agents. A colouring agent, for example comprising a dye or colorant, may in some examples be used as a coalescing agent or a coalescence modifier agent, and/or as a print agent to provide a particular colour for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

According to the present disclosure, there is provided a non-transitory machine-readable storage medium encoded with instructions executable by a processor. The machine-readable storage medium comprises instructions to perform at least part of the method described herein. The method may be used in conjunction with any other programs.

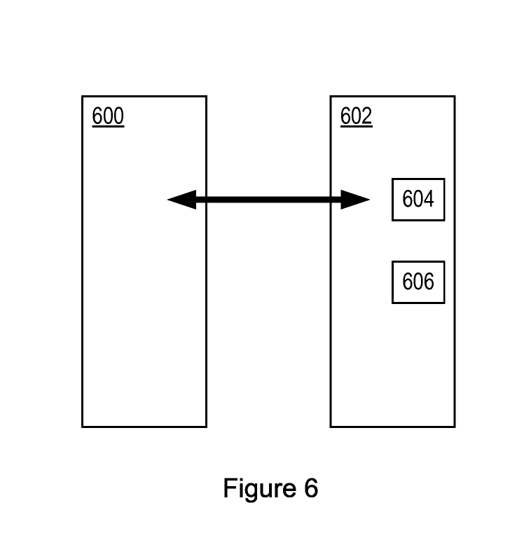

FIG. 6 is a block diagram of a computing system according to an example. There is provided a non-transitory machine-readable storage medium 602 encoded with instructions 604, 606 executable by a processor 600. The machine-readable storage medium comprises instructions to perform at least part of the method described herein. For example, the machine-readable storage medium 602 comprises instructions 604 to determine, for each load (for example, in a circuit and such as a device) in a set of loads, a level of harmonic control to set for an alternating current voltage supplied to the load, wherein the level of harmonic control indicates a period in a cycle of the alternating current voltage in which to drop the alternating current voltage, and instructions 606 to control, for each load in the set of loads, the alternating current voltage supplied to the load by dropping the alternating current voltage in the period indicated by the determined level of harmonic control for the load.

Examples in the present disclosure can be provided as methods, systems or machine-readable instructions, such as any combination of software, hardware, firmware or the like. Such machine-readable instructions may be included on a machine-readable storage medium (including but is not limited to disc storage, CD-ROM, optical storage, etc.) having machine-readable program code therein or thereon.

The present disclosure is described with reference to flow charts and/or block diagrams of the method, apparatus and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realised by machine-readable instructions.

The machine-readable instructions may, for example, be executed by a general purpose computer, a special purpose computer, an embedded processor or processors of other programmable data processing devices to realise the functions described in the description and figures. For example, a processing apparatus or processor may execute the machine-readable instructions. Thus, functional modules of the apparatus and devices (such as the sensor module, the processing module, the control module and the heating module) may be implemented by a processor executing machine-readable instructions stored in a memory, or a processor operating in accordance with instructions embedded in logic circuitry. The term “processor” is to be interpreted broadly to include a processing unit, central processing unit (CPU), application-specific integrated circuit (ASIC), logic unit, programmable gate array, etc. The methods and functional modules may all be performed by a single processor or divided amongst several processors.

Such machine-readable instructions may also be stored in a machine-readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices provide a means for realising functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit and scope of the present disclosure. It should be noted that the above-mentioned examples illustrate rather than limit what is described herein, and that those skilled in the art will be able to design many alternative implementations without departing from the scope of the appended claims. For example, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
for each device in an array of devices:
acquiring a level of harmonic control to apply to an alternating current voltage powering the device, wherein the level of harmonic control defines a period in a cycle of the alternating current voltage in which to drop the alternating current voltage; and
controlling the alternating current voltage powering the device by dropping the alternating current voltage in the period defined by the acquired level of harmonic control.

2. A method according to claim 1, wherein the devices in the array of devices are controlled separately.

3. A method according to claim 1, wherein the devices are controlled using different levels of harmonic control.

4. A method according to claim 1, wherein the level of harmonic control is acquired from a database comprising data representing different levels of harmonic control or is acquired as a predetermined level of harmonic control for the device.

5. A method according to claim 1, wherein acquiring a level of harmonic control to apply to an alternating current voltage powering the device comprises:
acquiring a level of harmonic control to apply to the alternating current voltage powering the device that is a lowest level of harmonic control to generate harmonics in the alternating current voltage that conform to a regulation.

6. A method according to claim 1 comprising:
determining an amount of power in the device; and
wherein acquiring a level of harmonic control to apply to the alternating current voltage powering the device comprises:
acquiring a level of harmonic control to apply to the alternating current voltage powering the device based on the determined amount of power in the device.

7. A method according to claim 1, comprising:
determining a speed at which the device is operating; and
wherein acquiring a level of harmonic control to apply to the alternating current voltage powering the device comprises:
acquiring a level of harmonic control to apply to the alternating current voltage powering the heating device based on the determined speed at which the device is operating.

8. A method according to claim 1, comprising:
determining a level of noise experienced by the device; and
wherein acquiring a level of harmonic control to apply to the alternating current voltage powering the device comprises:
acquiring a level of harmonic control to apply to the alternating current voltage powering the heating device based on the determined level of noise experienced by the device.

9. A method according to claim 1, wherein the device is a heating device and the method comprises:
providing heat to a build surface using the device powered by the controlled alternating current voltage.

10. A method according to claim 9, wherein the level of harmonic control to apply to the alternating current voltage powering the heating device is acquired such that the array of heating devices heat the build surface uniformly.

11. A method according to claim 1 comprising:
generating an object by applying layers of build material to the build surface and repeating the method of claim 1 for each layer of build material.

12. An apparatus comprising:
an acquisition module to acquire, for each device in an array of devices, a level of harmonic control to apply to an alternating current voltage provided to the device, wherein the level of harmonic control identifies a period in a cycle of the alternating current voltage in which to cease providing the alternating current voltage; and
a control module to control, for each device in the array of devices, the alternating current voltage provided to the device by ceasing to provide the alternating current voltage in the period identified by the acquired level of harmonic control for the device.

13. An apparatus according to claim 12 comprising:
the array of devices, wherein the control module controls the alternating current voltage provided to the devices.

14. An apparatus according to claim 12 comprising:
a sensor module to determine an amount of power in the device.

15. A non-transitory machine-readable storage medium encoded with instructions executable by a processor, the machine-readable storage medium comprising:
instructions to determine, for each load in a set of loads, a level of harmonic control to set for an alternating current voltage supplied to the load, wherein the level of harmonic control indicates a period in a cycle of the alternating current voltage in which to cut the alternating current voltage; and
instructions to control, for each load in the set of loads, the alternating current voltage supplied to the load by cutting the alternating current voltage in the period indicated by the determined level of harmonic control for the load.
